(19) United States
(12) Patent Application Publication
(10) Pub. No.: US 2021/0403053 A1
(43) Pub. Date: Dec. 30, 2021

(54) METHOD FOR CALLING A VEHICLE TO USER'S CURRENT LOCATION

(71) Applicant: LG ELECTRONICS INC., Seoul (KR)

(72) Inventors: Sung Hwan CHOI, Seoul (KR); Joong Hang KIM, Seoul (KR)

(73) Assignee: LG ELECTRONICS INC., Seoul (KR)

(21) Appl. No.: 16/490,069

(22) PCT Filed: Jun. 14, 2019
(86) PCT No.: PCT/KR2019/007225

§ 371 Date: Aug. 29, 2019

(51) Int. Cl. B60W 60/00; G06T 7/73; H04N 5/232; G06T 11/00; H04W 4/029; H04W 4/40; G08G 1/00; G01C 21/34; G01C 21/00; G06F 16/909; G06Q 30/04

(52) U.S. Cl. CPC B60W 60/00253; G06Q 2240/00; H04N 5/23222; H04N 5/232945; G06T 11/00; H04W 4/029; H04W 4/40; G08G 1/202; G01C 21/3453; G01C 21/3896; G06F 16/909; G06Q 30/04; B60W 2556/50; B60W 2556/60; B60W 2420/42; G06T 7/74

(57) ABSTRACT

Disclosed herein is a method for exactly estimating the current location of a user and calling a vehicle to the estimated location on the basis of a GPS coordinate of a user terminal and a coordinate of a feature point recorded by the user terminal. The method for calling a vehicle according to an embodiment includes transmitting a GPS coordinate of a terminal to a server when a service request signal is input by a user, receiving tile data corresponding to the GPS coordinate of a terminal from the server, recording an external image using a camera, and extracting a feature point from the recorded external image, identifying any one reference feature point matched with the feature point extracted from the external image among a plurality of reference feature points included in the tile data, determining a terminal coordinate on the basis of a coordinate of the identified reference feature point and on the basis of a change in a location of the reference feature point in the external image, and transmitting the determined terminal coordinate to the server, and receiving a vehicle coordinate of a vehicle for transportation allocated to the terminal coordinate from the server.

### TECHNICAL FIELD

The present disclosure relates to a method for exactly estimating the current location of a user and calling a vehicle to the estimated location, on the basis of a GPS coordinate of a user terminal and a coordinate of a feature point recorded by the user terminal.

### BACKGROUND

Conventionally, users have to wait for taxis when the users use the taxis to move to a destination by receiving transportation services provided by the taxis. However, in recent years, users may call taxis to the users' location through an application installed in the users' terminal to travel to a destination.

In the process, location-based services using a global positioning system are provided as a means to determine the location of a user. However, GPS coordinates may not exactly indicate the location of a user due to various factors (e.g., conditions for receiving radio waves, refraction of satellite signals, reflection, noise of a transmitter and a receiver, a distance between satellites).

Accordingly, even when a user calls a taxi, the taxi driver may not find the user or the user may not find the taxi called by the user. Additionally, there are times when a taxi stops on the opposite side of the road from the user, or across from the user. This causes inconvenience to the user. Further, a path to a destination may be changed. This leads to a decline in the satisfaction of the user and an increase in the taxi fare.

Thus, there is a growing need for a method of calling a vehicle exactly to the current location of a user when services for calling a vehicle are provided to the user.

### DISCLOSURE

### Technical Problems

One objective of the present disclosure is to exactly estimate the current location of a user using feature points near the user to call a vehicle.

Another objective of the present disclosure is to allow a user to find out a vehicle called by the user among a plurality of vehicles on the road.

Yet another objective of the present disclosure is to allow a user to find out a pickup location that requires a lower expected driving fare to a destination than a current location.

Objectives of the present disclosure are not limited to what has been described. Additionally, other objectives and advantages that have not been mentioned may be clearly understood from the following description and may be more clearly understood from embodiments. Further, it will be understood that the objectives and advantages of the present disclosure may be realized via means and a combination thereof that are described in the appended claims.

### Technical Solutions

The present disclosure may exactly estimate the current location of a user, by determining a terminal coordinate on the basis of a coordinate of a reference feature point included in tile data corresponding to a GPS coordinate of a user terminal, and on the basis of a change in a location of a reference feature point in an image recorded by a camera of the user terminal.

Further, the present disclosure may allow a user to find out a vehicle called by the user among a plurality of vehicles on the road, by displaying an augmented image indicating a vehicle for transportation in a recorded image when an area including a vehicle coordinate is recorded by a camera of a user terminal.

Furthermore, the present disclosure may allow a user to find out a pickup location that requires a lower expected driving fare to a destination than a current location, by determining a suggested pickup location at which a distance between the suggested pickup location and a terminal coordinate is within a preset distance, and at which an expected driving fare from the suggested pickup location to a destination is lower than an expected driving fare from the terminal coordinate to the destination and by transmitting the determined suggested pickup location to a user terminal.

### Advantageous Effects

The present disclosure may call a vehicle exactly to the current location of a user by estimating the location of the user using feature points near the user, thereby maximize user convenience in providing transportation services.

Further, the present disclosure may allow a user to find out a vehicle called by the user among a plurality of vehicles on the road, thereby solving the problem that the user may not recognize the vehicle called by the user when the vehicle for providing transportation services arrives near the user.

Furthermore, the present disclosure may allow a user to find out a pickup location that requires a lower expected driving fare to a destination than a current location, thereby providing efficient and economic transportation services to the user.

Specific effects of the present disclosure together with the above-described effects are described in the detailed description of embodiments.

### DESCRIPTION OF THE DRAWINGS

FIG. 1 is a view illustrating a transportation-service providing system according to an embodiment.

FIG. 2 is an internal block diagram illustrating the server, the user terminal and the vehicle in FIG. 1.

FIG. 3 is a flow chart illustrating a method for calling a vehicle according to an embodiment.

FIG. 4 is a view illustrating examples of a three-dimensional map and tile data stored in a database of a server.

FIG. 5 is a view illustrating an example in which external images are recorded using a camera of a user terminal.

FIG. 6 is a view illustrating a guide screen that guides movements of a camera when external images are recorded.

FIG. 7 is a view illustrating an alarm that is displayed when no feature point is identified in external images.

FIG. 8 is a view illustrating an example of an augmented image indicating a vehicle for transportation.

FIG. 9 is a view illustrating an example of an augmented image showing a suggested pickup location and a path to the suggested pickup location.

FIG. 10 is a flow chart illustrating a process during which a server, a user terminal, and a vehicle operate to provide transportation services.

### BEST MODE

The above-described objectives, features and advantages are specifically described with reference to the attached drawings hereunder such that one having ordinary skill in the art to which the present disclosure pertains may easily implement the technical spirit of the disclosure. In describing the disclosure, detailed description of publicly known technologies in relation to the disclosure is omitted if it is deemed to make the gist of the present disclosure unnecessarily vague. Below, preferred embodiments of the present disclosure are specifically described with reference to the attached drawings. Throughout the drawings, identical reference numerals denote identical or similar elements.

The present disclosure relates to a method for exactly estimating the current location of a user and calling a vehicle to the estimated location, on the basis of a GPS coordinate of a user terminal and a coordinate of a feature point recorded by the user terminal.

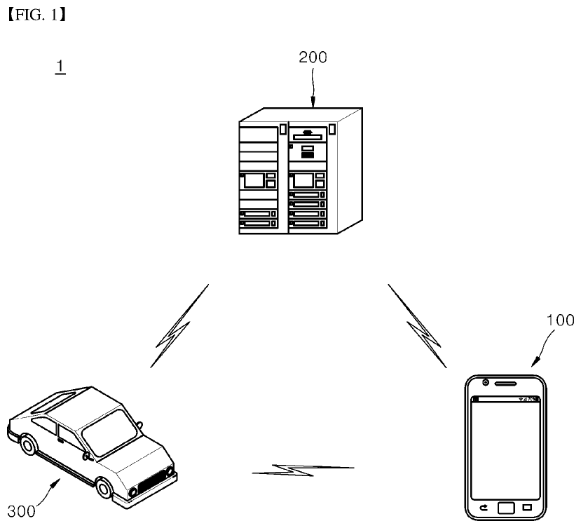

Below, a transportation-service providing system according to an embodiment, and a method for calling a vehicle using the system are specifically described with reference to FIGS. 1 to 10.

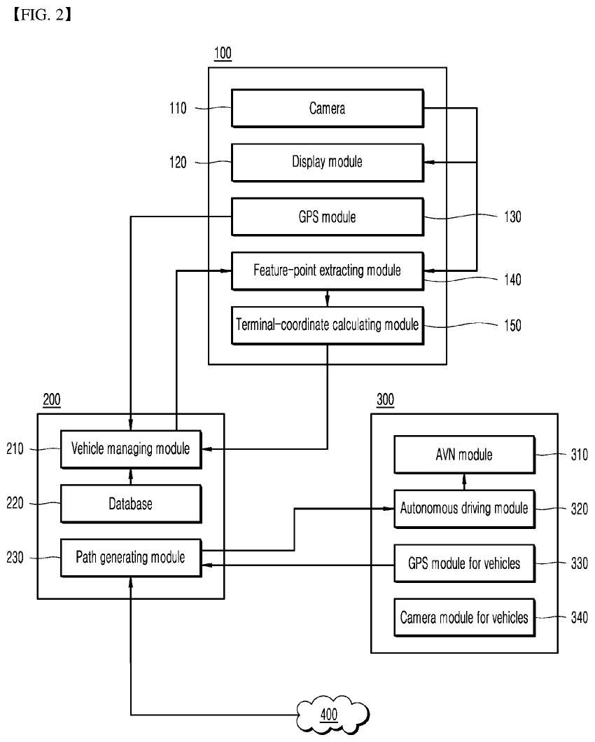

FIG. 1 is a view illustrating a transportation-service providing system according to an embodiment, and FIG. 2 is an internal block diagram illustrating the server, the user terminal and the vehicle in FIG. 1.

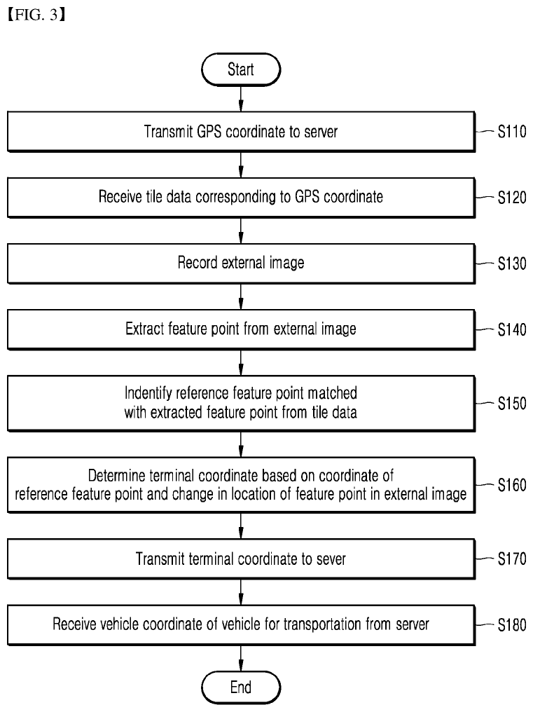

FIG. 3 is a flow chart illustrating a method for calling a vehicle according to an embodiment.

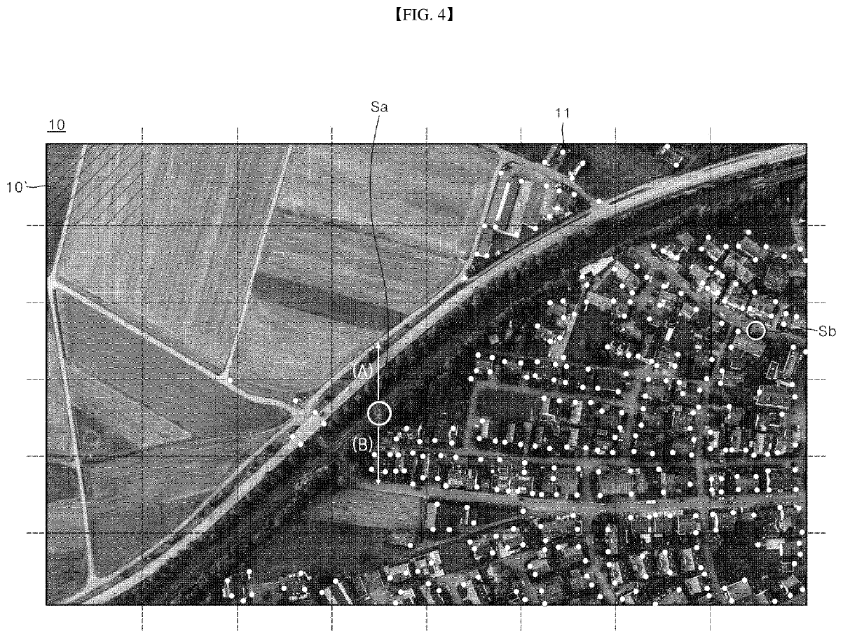

FIG. 4 is a view illustrating examples of a three-dimensional map and tile data stored in a database of a server.

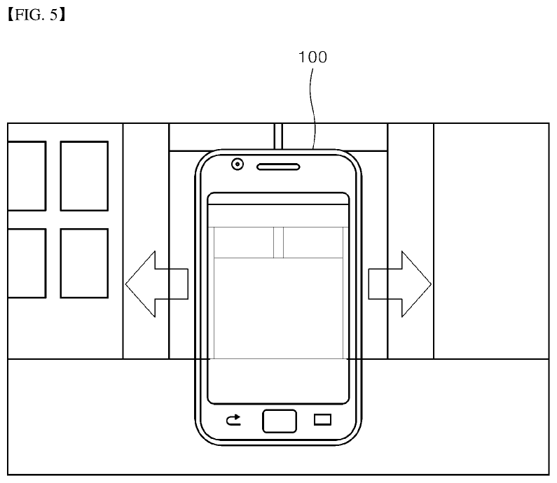

FIG. 5 is a view illustrating an example in which external images are recorded using a camera of a user terminal.

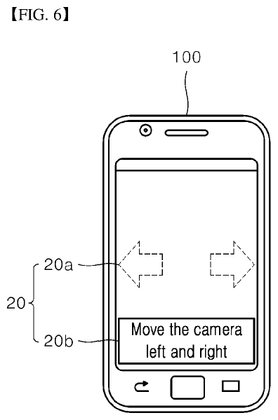

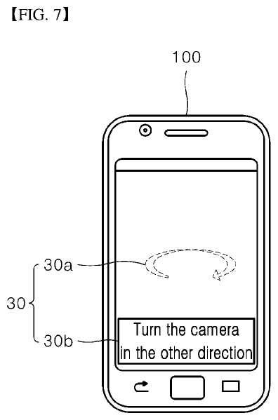

FIG. 6 is a view illustrating a guide screen that guides movements of a camera when external images are recorded, and FIG. 7 is a view illustrating an alarm that is displayed when no feature point is identified in external images.

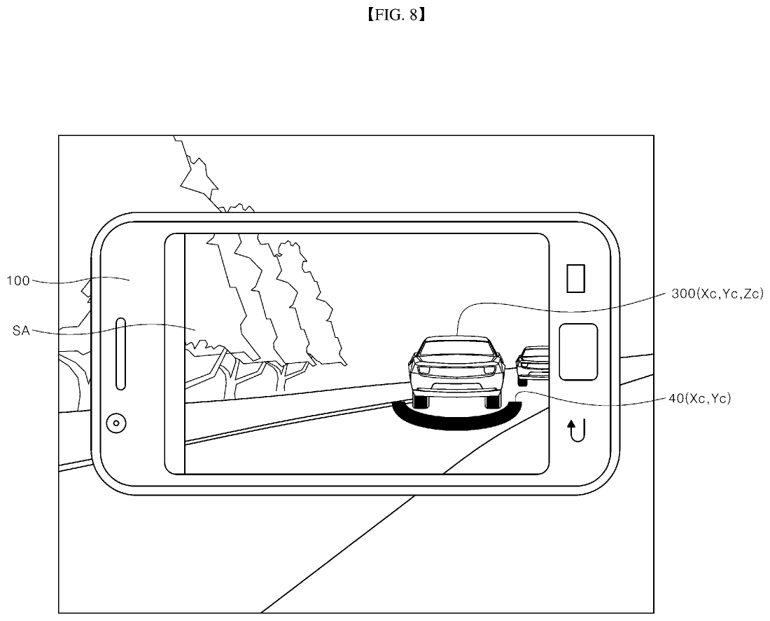

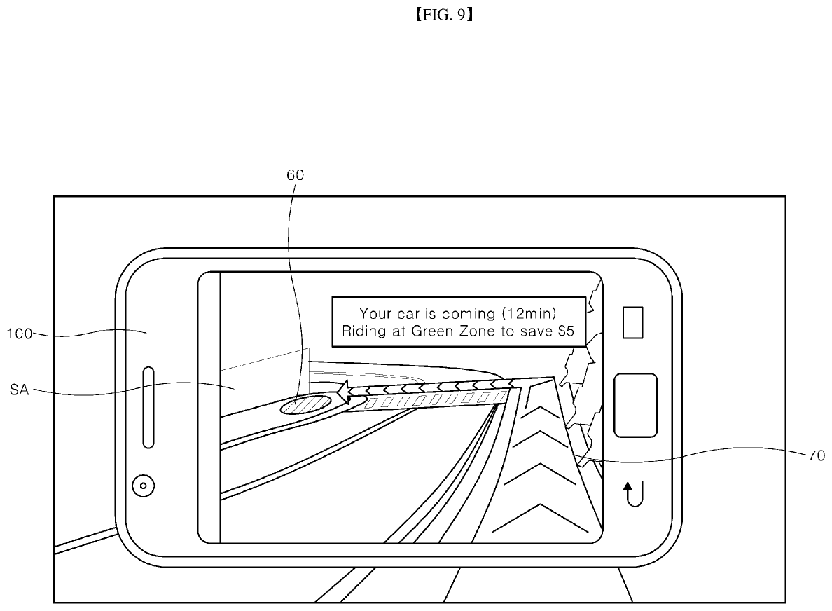

FIG. 8 is a view illustrating an example of an augmented image indicating a vehicle for transportation, and FIG. 9 is a view illustrating an example of an augmented image showing a suggested pickup location and a path to the suggested pickup location.

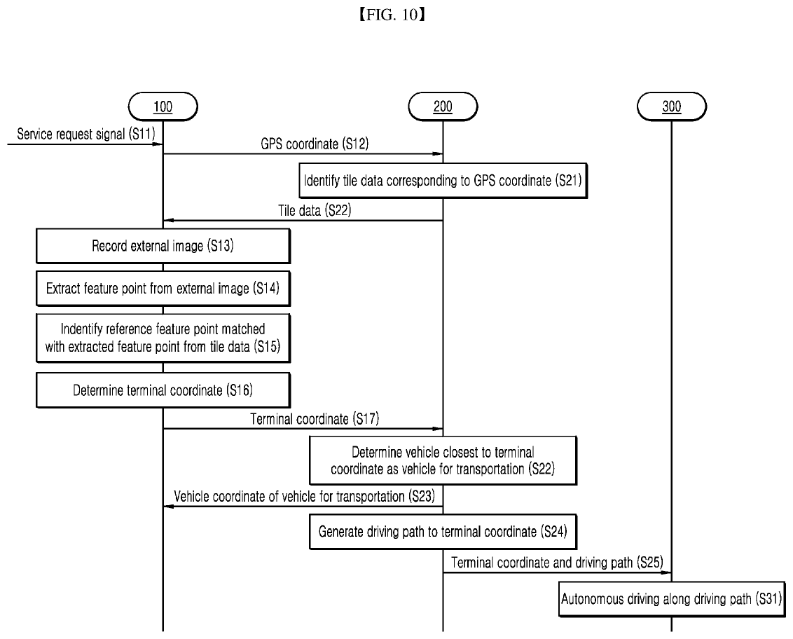

FIG. 10 is a flow chart illustrating a process during which a server, a user terminal and a vehicle operate to provide transportation services.

Referring to FIG. 1, a transportation-service providing system 1 according to an embodiment may include a user terminal 100, a server 200 and a vehicle 300. The transportation-service providing system 1 illustrated in FIG. 1 is based on an embodiment, and elements thereof are not limited to the embodiment illustrated in FIG. When necessary, some elements may be added, modified or removed.

The user terminal 100, the server 200, and the vehicle 300, which constitute the transportation-service providing system 1, may connect to a wireless network and may perform data communication with one another, and each element may use 5^{th} generation (5G) mobile communication services for data communication.

In the present disclosure, the vehicle 300, as any vehicle that provides transportation services to transport a user to a destination, may include a taxi or a shared vehicle that are currently used. Additionally, the vehicle 300 may include an autonomous vehicle, an electric vehicle, a fuel cell electric vehicle, and the like that have been developing.

When the vehicle 300 is an autonomous vehicle, the vehicle 300 may be linked with any artificial intelligence modules, drones, unmanned aerial vehicles, robots, augmented reality (AR) modules, virtual reality (VR) modules, 5G mobile communication services and devices, and the like.

Below, suppose that a vehicle 300 constituting the transportation-service providing system 1 is an autonomous vehicle, for convenience of description.

The vehicle 300 may be managed by a transportation company, and in a below-described process of providing transportation services, a user may board the vehicle 300.

A plurality of human machine interfaces (HMI) may be provided in the vehicle 300. Basically, the HMI may perform the function of outputting information on the vehicle 300 or on the state of the vehicle 300 to a driver visually and acoustically through a plurality of physical interfaces (e.g., an AVN module 310). Additionally, in the process of providing transportation services, the HMI may receive user manipulation to provide transportation services, or may output details about services to a user. Elements inside the vehicle 300 are specifically described hereunder.

The server 200 may be built on the basis of a cloud, and may store and manage information collected from the user terminal 100 and the vehicle 300 that connect to a wireless network. The server 200 may be managed by a transportation company operating vehicles 300, and may control vehicles 300 using wireless data communication.

Referring to FIG. 2, the user terminal 100 according to an embodiment may include a camera 110, a display module 120, a GPS module 130, a feature-point extracting module 140, and a terminal-coordinate calculating module 150. Additionally, the server 200 according to an embodiment may include a vehicle managing module 210, a database 220, and a path generating module 230. Further, the vehicle 300 according to an embodiment may include AVN (audio, video, and navigation) modules 310, an autonomous driving module 320, a GPS module for vehicles 330, and a cameral module for vehicles 340.

Internal elements of the user terminal 100, the server 200 and the vehicle 300 that are illustrated in FIG. 2 are provided as examples, and the elements are not limited to the example in FIG. 2. When necessary, some elements may be added, modified or removed. Though not additionally illustrated in FIG. 2, a communication module may be naturally included in the user terminal 100, the server 200 and the vehicle 300 for mutual data communication.

Each of the modules in the user terminal 100, the server 200 and the vehicle 300 may be implemented as at least one physical element among application specific integrated circuits (ASICs), digital signal processors (DSPs), digital signal processing devices (DSPDs), programmable logic devices (PLDs), field programmable gate arrays (FPGAs), processors, controllers, micro-controllers, and microprocessors.

Referring to FIG. 3, a method for calling a vehicle according to an embodiment may include transmitting a GPS coordinate of a terminal to a server 200 (S1110), and receiving tile data corresponding to the GPS coordinate of a terminal from the server 200 (S120).

Next, the method for calling a vehicle may include recording an external image (S130), extracting a feature point from the recorded external image (S140), and identifying a reference feature point 11 matched with the extracted feature point from the tile data (S150).

Next, the method for calling a vehicle may include determining a terminal coordinate on the basis of a coordinate of the reference feature point 11 and on the basis of a change in a location of the feature point in the external image (S160), and transmitting the terminal coordinate to the server 200 (S170), and receiving a vehicle coordinate of a vehicle for transportation 300 from the server 200 (S180).

The method for calling a vehicle may be performed by the above-described user terminal 100, and the user terminal 100 may perform data communication with the server 200 to carry out the operation in each of the steps in FIG. 3.

Below, each of the steps constituting the method for calling a vehicle is specifically described with reference to the attached drawings.

A user terminal 100 may transmit a GPS coordinate of the terminal to a server 200 when a service-request signal is input (S110).

The service-request signal, as a signal for requesting transportation services, may be a signal for initiating a call for a vehicle 300. An application in relation to transportation services (hereinafter referred to as transportation application) may be previously installed in the user terminal 100. The transportation application may output an interface for inputting a service-request signal through a display module 120, and a user may input a service-request signal through the interface.

Regardless of the input of a service-request signal, a GPS module 130 may acquire a three-dimensional coordinate, at which the GPS module 130 is located, by interpreting a satellite signal output by an artificial satellite. The three-dimensional coordinate acquired by the GPS module 130 may be a GPS coordinate of the terminal because the GPS module 130 is provided in the user terminal 100.

When the service-request signal is input through the display module 120 as described above, the GPS module 130, in response to this, may transmit the GPS coordinate of the terminal to the server 200.

Then a feature-point extracting module 140 may receive tile data corresponding to the GPS coordinate of the terminal from the server 200 (S120).

The server 200 may include a database 220 in which a three-dimensional map 10 comprised of a plurality of unit areas 10′, and tile data corresponding to each of the plurality of unit areas 10′ are previously stored. Specifically, information on the three-dimensional map 10 and on reference feature points (interest points) included in the three-dimensional map 10 may be previously stored in the database 220. In this case, the three-dimensional map 10 may be comprised of unit areas 10′, and information on reference feature points corresponding to each of the unit areas 10′ may be defined as tile data.

Referring to FIG. 4, the three-dimensional map 10 may be comprised of a plurality of unit areas 10′. The unit areas 10′ may be divided on the basis of various standards. Below, suppose that unit areas 10′ are divided in the form of matrix that for description of convenience. That is, the three-dimensional map 10 in FIG. 4 may be comprised of 6 columns and 8 rows and may be divided into a total of 48 unit areas 10′.

When a terminal GPS coordinate is received from the user terminal 100, a vehicle managing module 210 in the server 200 may identify a unit area 10′ including the GPS coordinate with reference to the database 220. A three-dimensional coordinate concerning any location on the three-dimensional map 10 may be stored in the database 220. The vehicle managing module 210 may determine which unit area 10′ includes the terminal GPS coordinate by comparing the terminal GPS coordinate, received from the user terminal 100, and the three-dimensional coordinate on the three-dimensional map 10.

For example, when the terminal GPS coordinate is Sa in FIG. 4, the vehicle managing module 210 may identify the unit area 10′ in column 4 and row 4 as a unit area 10′ including the GPS coordinate. Additionally, when the terminal GPS coordinate is Sb in FIG. 4, the vehicle managing module 210 may identify the unit area 10′ in column 3 and row 8 as a unit area 10′ including the GPS coordinate.

When the unit area 10′ is identified, the vehicle managing module 210 may extract tile data corresponding to the unit area 10′ from the database 220, and may transmit the extracted tile data to the user terminal 100.

The tile data may include a descriptor of each reference feature point 11 included in the unit area 10′. The reference feature point 11, as a feature point stored in the database 220, may specifically denote a feature point in the three-dimensional map 10.

Additionally, for example, the descriptor of the reference feature point 11, as a parameter defining a reference feature point 11, may include an angle, a pose and the like of the reference feature point 11.

The descriptor may be extracted through various algorithms such as a scale-invariant feature transform (SIFT) algorithm, a speeded-up robust features (SURF) algorithm, and the like that are publicly known to those in the art to which the disclosure pertains.

The vehicle managing module 210, as described above, may identify a unit area 10′ including a terminal GPS coordinate, and may transmit tile data corresponding to the identified unit area 10′ to the user terminal 100. However, when no reference feature point 11 is in the unit area 10′, there may be no tile data.

When there is no tile data corresponding to a unit area 10′ including a terminal GPS coordinate, the server 200 may further extract tile data corresponding to an adjacent area adjacent to the unit area 10′, and may transmit the extracted tile data to the user terminal 100.

For example, when a terminal GPS coordinate is Sa as in FIG. 4, there may be no tile data corresponding to the unit area 10′. In this case, the server 200 may determine areas in column 3 and row 3, in column 3 and row 4, in column 3 and row 5, in column 4 and row 3, in column 4 and row 5, in column 5 and row 3, in column 5 and row 4, and in column 5 and row 5, which are adjacent to the unit area 10′, as adjacent areas, may further extract tile data corresponding to the adjacent areas, and may transmit the extracted tile data to the user terminal 100.

When the feature-point extracting module 140 receives the tile data from the server 200, the user terminal 100 may record external images using a camera 110 (S130), and may extract feature points from the recorded external images (S140).

Specifically, when the feature-point extracting module 140 receives the tile data from the server 200, a transportation application installed in the user terminal 100 may execute the camera 110 to record feature points. The user may record external images using the camera 110 executed by the transportation application.

The feature-point extracting module 140 may extract feature points from the external images using various algorithms. For example, the feature-point extracting module 140 may extract feature points using algorithms such as a Harris Corner algorithm, a Shi-Tomasi algorithm, an SIFT (scale-invariant feature transform) algorithm, an SURF (speeded-up robust features) algorithm, a features from accelerated segment test (FAST) algorithm, an adaptive and generic corner detection based on the accelerated segment test (AGAST) algorithm, a fast keypoint recognition in ten lines of code (Ferns) algorithm and the like that are employed in the art to which the disclosure pertains.

The external image may be two or more pictures in which the location of a feature point is changed, or may be a moving image in which the location of a feature point is being changed.

Referring to FIG. 5, the user terminal 100 may record an external image by sliding the camera 110 such that the location of a feature point may be changed in the external image, to record the external image that is described above.

As an example, the camera 110 may move left and right or up and down in the user terminal 100. In this case, the transportation application may slide the camera 110 left and right or up and down, and the camera 110 may record external images while sliding.

As another example, the camera 110 may be fixed to the user terminal 100. In this case, the transportation application may lead a user such that the user may slide the camera 110 manually, and the user may record external images while sliding the camera 110 left and right or up and down on the basis of the lead.

Specifically, referring to FIG. 6, the transportation application may output a guide screen 20 that guides movements of the camera 110 through the display module 120 after the camera 110 is executed. The guide screen 20 may include a guide image 20a and a guide text 20b that guide left and right movements of the camera 110. The user may move the user terminal 100 according to a direction displayed on the guide screen 20, and the camera 110 may move according to the direction displayed on the guide screen 20 and may record external images.

While the camera 110 records external images, the feature-point extracting module 140 may identify and extract feature points in the external images in real time. However, when no feature point is identified in the external images, the transportation application may output an alarm.

Referring back to FIG. 4, a user having a user terminal 100 with a terminal GPS location of Sa may record an external image in direction (A) using the camera 110. In this case, the recorded external image may not include feature points. Accordingly, the feature-point extracting module 140 may not identify feature points in the external image.

In this case, the transportation application, as illustrated in FIG. 7, may output an alarm 30 that guides a change in the direction of the camera 110 through the display module 120. The alarm 30 may include an image 30a and a text 30b that guide a change in the direction of the camera 110.

The user may change the direction of the camera 110 according to a direction displayed in the alarm 30 into direction (B) in FIG. 4, and the camera 110 may record an external image in direction (B). As illustrated in FIG. 4, a plurality of reference feature points 11 are present in direction (B). Accordingly, the external image may include feature points, and the feature-point extracting module 140 may identify and extract the feature points in the external image.

The feature-point extracting module 140 may identify any one reference feature point 11 matched with the feature point extracted from the external image among the plurality of reference feature points 11 included in the tile data received from the server 200 (S150).

The feature point extracted from the external image may be any one among the plurality of reference feature points 11 included in the tile data. The feature-point extracting module 140 may compare the feature point extracted from the external image and the plurality of reference feature points 11 included in the tile data, and may identify any one reference feature point 11 matched with the extracted feature point.

Specifically, the feature-point extracting module 140 may determine a descriptor of the feature point extracted from the external image, and may identify any one reference feature point 11 having a descriptor matched with the determined descriptor. The feature-point extracting module 140 may determine a descriptor of a feature point by extracting a descriptor of the feature point included in the external image. The algorithm used to extract a descriptor is described above. Accordingly, detailed description is omitted.

As an example, the feature-point extracting module 140 may identify any one reference feature point 11 having a descriptor the same as the extracted descriptor by comparing the extracted descriptor, and the descriptor of each reference feature point 11 included in the tile data.

As another example, the feature-point extracting module 140 may identify any one reference feature point 11 having a descriptor most similar to the extracted descriptor by comparing the extracted descriptor, and the descriptor of each reference feature point 11 included in the tile data.

Specifically, the feature-point extracting module 140 may identify any one reference feature point 11 with the smallest difference by comparing each extracted descriptor (e.g., angles, and poses of feature points) and each descriptor of each of the reference feature points 11 included in the tile data.

Additionally, the feature-point extracting module 140 may generate an affinity matrix on the basis of the extracted descriptor and the descriptor of the reference feature point 11. In this case, the feature-point extracting module 140 may identify any one reference feature point 11 maximizing the magnitude of eigenvalues of the affinity matrix.

A terminal-coordinate calculating module 150 may determine a terminal coordinate on the basis of coordinates of the reference feature points 11 identified according to the above-described method and on the basis of a change in locations of the reference feature points 11 in the external image (S160).

A three-dimensional coordinate of the reference feature point 11 in the unit area 10′ may be included in the tile data received from the server 200. The external image, as described above, is recorded by sliding the camera 110. Accordingly, the location of the reference feature point 11 in the external image may be changed.

The terminal-coordinate calculating module 150 may calculate a three-dimensional distance between the camera 110 and an abject, on the basis of an internal parameter of the camera 110, a coordinate of the reference feature point 11, and an amount of change in the location of the reference feature point 11 in the external image. For example, the terminal-coordinate calculating module 150 may calculate a three-dimensional distance between the camera 110 and an object using various structure from motion (SFM) algorithms.

Specifically, the terminal-coordinate calculating module 150 may calculate a relative distance between the reference feature point 11 and the camera 110 using an SFM algorithm. Next, the terminal-coordinate calculating module 150 may calculate a three-dimensional displacement value between the reference feature point 11 and the camera 110 on the basis of the calculated relative distance and on the basis of a pitch, roll and yaw of the camera 110, and may determined a terminal coordinate by applying the three-dimensional displacement value to the coordinate of the reference feature point 11.

For example, when a coordinate of the reference feature point 11 is (X1, Y1, Z1) and the three-dimensional displacement value is calculated as (ΔX, ΔY, ΔZ), the terminal-coordinate calculating module 150 may determined (X1+ΔX, Y1+ΔY, Z1+ΔZ), in which the three-dimensional displacement value is applied to the coordinate of the reference feature point 11, as a terminal coordinate.

The present disclosure briefly describes that various SFM algorithms may be used to calculate a three-dimensional displacement value. However, various algorithms for image analysis, which are employed in the art to which the disclosure pertains, may be applied in addition to the SFM algorithms.

The present disclosure, as described above, may allow a user to call a vehicle 300 to the current location of the user by exactly estimating the location of the user using feature points around the user, thereby enhancing convenience of the user in providing transportation services.

When a terminal coordinate is determined, the terminal-coordinate calculating module 150 may transmit the terminal coordinate to the server 200 (S170).

The vehicle managing module 210 of the server 200 may allocate a vehicle 300 to the user on the basis of the terminal coordinate received from the user terminal 100. In the present disclosure, the vehicle 300 allocated to a user is defined as a vehicle for transportation 300.

The server 200 may determine any one vehicle 300 with the shortest distance to the terminal coordinate as a vehicle for transportation 300 among a plurality of vehicles 300 that are currently available.

As an example, the vehicle managing module 210 may determine any one vehicle 300 with the shortest straight distance to the terminal coordinate as a vehicle for transportation 300 among a plurality of vehicles 300 that are currently available.

As another example, the vehicle managing module 210 may determine any one vehicle 300 with the shortest travel distance to the terminal coordinate as a vehicle for transportation 300 among a plurality of vehicles 300 that are currently available. Specifically, even when a vehicle 300 with the shortest straight distance to the terminal coordinate is vehicle A, a vehicle 300 with the shortest travel distance to the terminal coordinate may be vehicle B depending to the structure of a road. In this case, the vehicle managing module 210 may determine vehicle B as a vehicle for transportation 300.

When the vehicle for transportation 300 is determined, the vehicle managing module 210 may transmit the terminal coordinate and a driving path to the terminal coordinate to the vehicle for transportation 300.

Specifically, a path generating module 230 may identify the current location of the vehicle 300 through a GPS module for vehicles 330 of the vehicle 300, and may generate a driving path from the identified current location to the terminal coordinate.

The path generating module 230 may generate a driving path on the basis of traffic condition information. To this end, the path generating module 230 and a traffic information server 400 connect to a network, and the path generating module 230 may receive information on current traffic condition from the traffic information server 400. The traffic information server 400, as a server that manages information on traffic in real time such as information on roads, traffic congestion, road surface condition and the like, may be a server managed nationally or privately.

Any methods employed in the art to which the present disclosure pertains may be applied to a method for generating a driving path by reflecting traffic condition information. Accordingly, detailed description is omitted.

When the driving path is generated, the server 200 may transmit the driving path to the vehicle for transportation 300. An autonomous driving module 320 in the vehicle for transportation 300 may move autonomously along the driving path received from the server 200.

Specifically, the autonomous driving module 320 may control driving of the vehicle for transportation 300 along the driving path, and to this end, algorithms for maintaining a distance between vehicles, preventing the vehicle for transportation 300 from escaping from the lane, tracking the lane, detecting signals, detecting a pedestrian, detecting a structure, sensing traffic conditions, autonomous parking and the like may be applied to control exerted by the autonomous driving module 320 over the vehicle for transportation 300. In addition to the above-described algorithms, various algorithms employed in the art to which the disclosure pertains may be applied to autonomous driving.

When the vehicle for transportation 300 starts to move autonomously, the server 200 may transmit a vehicle coordinate of the vehicle for transportation 300 to the user terminal 100, and the user terminal 100 may receive the vehicle coordinate of the vehicle for transportation 300 allocated to the terminal coordinate (S180).

The vehicle coordinate may be a coordinate acquired by the GPS module for vehicles 330. The vehicle coordinate may also be a coordinate calculated according to a method the same as the above-described method for acquiring a terminal coordinate.

Specifically, the server 200 may receive a GPS coordinate from the GPS module for vehicles 330, and may transmit tile data corresponding to the received GPS coordinate to the vehicle for transportation 300. Next, the vehicle for transportation 300 may record an external image using a cameral module for vehicles 340, and may extract feature points from the recorded external image.

Next, the vehicle for transportation 300 may identify any one reference feature point 11 matched with the feature point extracted from the external image among a plurality of reference feature points 11 included in the tile data, and may determine a vehicle coordinate on the basis of the coordinate of the identified reference feature point 11 and on the basis of a change in the location of the reference feature point 11 in the external image.

The method for determining a coordinate is described above with reference to FIG. 3. Accordingly, detailed description is omitted.

When the vehicle coordinate is received, the transportation application may display a map through the display module 120, and may display the vehicle coordinate as an image on the map. Accordingly, the user may confirm the current location of the vehicle for transportation 300 in real time.

When the vehicle for transportation 300 is moving to the terminal coordinate, the user terminal 100 may record an area including the vehicle coordinate received from the server 200 using the camera 110, and the user terminal 100 may display an augmented image indicating the vehicle for transportation 300 located in the recorded area.

Referring to FIG. 8, the camera 110 may record an area (SA) in which the vehicle coordinate (e.g., a three-dimensional coordinate) is included, i.e., an area (SA) including a location indicated by the vehicle coordinate. A plurality of vehicles 300 including the vehicle for transportation 300 may be located in the area (SA). Accordingly, the plurality of vehicles 300 may be recorded by the camera 110. In this case, the user terminal 100 may display an augmented image 40 indicating the vehicle for transportation 300.

As an example, the user terminal 100 may confirm the location of the vehicle for transportation 300 by recognizing identification means such as a barcode, a QR code, a number plate and the like provided to the vehicle for transportation 300 through the camera 110, and may display an augmented image 40 at the confirmed location.

As another example, the user terminal 100 may convert the vehicle coordinate received from the server 200 into a two-dimensional coordinate, and may display an augment image 40 at a location corresponding to the two-dimensional coordinate in the recorded area (SA). Referring back to FIG. 8, the user terminal 100 may convert the three-dimensional vehicle coordinate (xc, yc, zc) into the two-dimensional coordinate (Xc, Yc) that will be displayed in the display module 120, and may display an augmented image 40 at the converted location (Xc, Yc), without recognizing the actual vehicle for transportation 300.

The present disclosure, as described above, may allow a user to find out a vehicle 300 called by the user among a plurality of vehicles 300 on the road, thereby solving the problem that the user may not recognize the vehicle 300 called by the user when the vehicle 300 for providing transportation services arrives near the user.

A user may input a destination through a transportation application. The transportation application may transmit the destination input by the user to the server 200. The server 200 may generate a path from a terminal coordinate to the destination, and may estimate a driving fare (hereinafter referred to as expected driving fare) that may be expected when the vehicle 300 moves along the path.

The server 200 may transmit the path to the destination and the expected driving fare to the user terminal 100, and the transportation application may display the path received from the server 200 on the map that is being displayed through the display module 120. Additionally, the transportation application may display the expected driving fare received from the server 200 as an image such as a pop-up and the like.

The server 200 may determine a suggested pickup location 60 at which a distance between the suggested pickup location 60 and the terminal coordinate is within a preset distance, and at which an expected driving fare from the suggested pickup location 60 to the destination is lower than an expected driving fare from the terminal coordinate to the destination.

Specifically, the server 200 may identify an area, in which an expected driving fare from the area to the destination is lower than an expected driving fare from the current terminal coordinate to the destination, among areas in which a distance between the areas and the terminal coordinate is within a preset distance (e.g., 100 m), and may determine the identified area as a suggested pickup location 60.

In other words, the server 200 may determine a location requiring a lower expected driving fare to the destination than a current location as a suggested pickup location 60 in an area in which the user may currently move on foot. When the suggested pickup location 60 is determined, the server 200 may transmit the suggested pickup location 60 to the user terminal 100.

The transportation application may display the suggested pickup location 60 received from the server 200 on the map that is being displayed through the display module 120.

When the suggested pickup location 60 is received from the server 200, the user terminal 100 may record an area including the suggested pickup location 60 using the camera 110, and may display an augmented image indicating the suggested pickup location 60 located in the recorded area.

Referring to FIG. 9, the camera 110 may record an area (SA) including the suggested pickup location 60 (e.g., a three-dimensional coordinate area). In this case, the user terminal 100 may display an augmented image (e.g., Green Zone) indicating the suggested pickup location 60.

Specifically, the user terminal 100 may convert a coordinate of the suggested pickup location 60 received from the server 200 into a two-dimensional coordinate that will be displayed in the display module 120, and may display an augmented image at a location corresponding to the two-dimensional coordinate in the recorded area (SA).

Additionally, the user terminal 100 may display a moving path 70 to the suggested pickup location 60 as an augmented image. In this case, the moving path 70 may be generated by the user terminal 100, or may be generated by the server 200 and transmitted to the user terminal 100.

Referring back to FIG. 9, the augmented image indicating the suggested pickup location 60, and the moving path 70 that may be moved on foot to the suggested pickup location 60 may be displayed as augmented images in the display module 120 of the use terminal 100.

Additionally, information on an expected driving fare (Riding at Green Zone to save $5), which may be saved when a pickup location is changed to the suggested pickup location 60, may be displayed in the display module 120. Further, the current state of the vehicle for transportation 300 (Your car is coming), expected time of arrival of the vehicle for transportation 300 (12 min) may also be displayed in the display module 120. Furthermore, various pieces of information required for transportation services may be naturally displayed in the display module 120.

When the suggested pickup location 60 is received from the server 200, the transportation application may output an interface as to whether a pickup location is changed to the suggested pickup location 60. When the user inputs a pickup-location change signal through the interface, the transportation application may transmit the location change signal to the server 200.

The server 200 may transmit the suggested pickup location 60 and a driving path to the suggested pickup location 60 to the vehicle for transportation 300 in response to the pickup-location change signal.

Specifically, the path generating module 230 in the server 200 may identify the current location of the vehicle 300, which is moving to a terminal location, through the GPS module for vehicles 330 of the vehicle 300, and may generate a driving path from the identified current location to the suggested pickup location 60. The method for generating a driving path by the path generating module 230 is described above. Accordingly, detailed description is omitted.

The present disclosure, as described above, may allow a user to find out a pickup location requiring a lower expected driving fare to a destination than a current location, thereby providing efficient and economic transportation services.

FIG. 10 is a view illustrating the process, during which a user terminal 100, a server 200, and a vehicle 300 operate to provide or receive transportation services, in a time series manner.

Referring to FIG. 10, a user may input a service request signal through a transportation application installed in the user terminal 100 to receive transportation services (S11). When the service request signal is input, the user terminal 100 may transmit a GPS coordinate of the terminal to the server 200 (S12).

The server 200 may identify tile data corresponding to the GPS coordinate of the terminal with reference to a database 220 (S21), and may transmit the identified tile data to the user terminal 100 (S22).

The user terminal 100 may record an external image using a camera 110 executed by a transportation application (S13), and may extract a feature point from the external image (S14). Next, the user terminal 100 may identify a reference feature point 11 matched with the extracted feature point from the tile data (S15).

Next, the user terminal 100 may determine a terminal coordinate on the basis of the coordinate of the reference feature point 11 and on the basis of a change in the location of the reference feature point 11 in the external image (S16), and may transmit the determined terminal coordinate to the server 200 (S17).

The server 200 may determine a vehicle 300 closest to the terminal coordinate as a vehicle for transportation 300 (S22), and may transmit a vehicle coordinate of the vehicle for transportation 300 to the user terminal 100 (S23). Additionally, the server 200 may generate a driving path from the current location of the vehicle for transportation 300 to the terminal coordinate (S24), and may transmit the terminal coordinate and the driving path to the vehicle for transportation 300 (S25).

The vehicle for transportation 300 may start autonomous driving along the driving path received from the server 200 and may move to the terminal coordinate at which the user is located (S31).
The present disclosure may be replaced, modified and changed in different forms by one having ordinary skill in the art to which the disclosure pertains within the technical spirit of the disclosure. Thus, the present disclosure should not be construed as being limited to the embodiments and drawings set forth herein.

1. A method for calling a vehicle, comprising:
transmitting a GPS coordinate of a terminal to a server when a service request signal is input by a user;
receiving tile data corresponding to the GPS coordinate of a terminal from the server;
recording an external image using a camera, and extracting a feature point from the recorded external image;
identifying any one reference feature point matched with the feature point extracted from the external image among a plurality of reference feature points included in the tile data;
determining a terminal coordinate on the basis of a coordinate of the identified reference feature point and on the basis of a change in a location of the reference feature point in the external image, and transmitting the determined terminal coordinate to the server; and
receiving a vehicle coordinate of a vehicle for transportation allocated to the terminal coordinate from the server.

2. The method of claim 1, wherein the server include a database in which a three-dimensional map comprised of a plurality of unit areas, and tile data corresponding to each of the plurality of unit areas are previously stored,
the tile data includes a descriptor of each reference feature point included in the unit area.

3. The method of claim 1, wherein the server identifies a unit area including the GPS coordinate of a terminal with reference to a database, and extracts tile data corresponding to the identified unit area, and transmits the extracted tile data to a user terminal.

4. The method of claim 3, wherein when there is no tile data corresponding to the identified unit area, the server further extracts tile data corresponding to an adjacent area adjacent to the unit area, and transmits the extracted tile data to a user terminal.

5. The method of claim 1, wherein the step of identifying any one reference feature point matched with the feature point extracted from the external image among a plurality of reference feature points included in the tile data comprises determining a descriptor of the extracted feature point, and identifying any one reference feature point having a descriptor matched with the determined descriptor.

6. The method of claim 5, wherein the step of identifying any one reference feature point having a descriptor matched with the determined descriptor comprises identifying any one reference feature point having a descriptor most similar a descriptor to the extracted feature point.

7. The method of claim 1, wherein the step of recording an external image using a camera comprises recording the external image by sliding the camera such that a location of the feature point is changed in the external image.

8. The method of claim 1, the step of recording an external image using a camera, comprising:
outputting a guide screen that guides movements of the camera; and
recording the external image by moving according to a direction displayed on the guide screen.

9. The method of claim 1, where the method further comprises outputting an alarm when the feature point is not identified in the external image.

10. The method of claim 1, wherein the step of determining a terminal coordinate on the basis of a coordinate of the identified reference feature point and on the basis of a change in a location of the reference feature point in the external image comprises calculating a three-dimensional displacement value between the reference feature point and the camera on the basis of the coordinate of the reference feature point and on the basis of a change in the location of the reference feature point in the external image, and determining the terminal coordinate by applying the calculated three-dimensional displacement value to the coordinate of the reference feature point.

11. The method of claim 1, wherein the server determines any one vehicle with the shortest distance to the terminal coordinate as the vehicle for transportation, and transmits the terminal coordinate and a driving path to the terminal coordinate to the determined vehicle for transportation.

12. The method of claim 11, wherein the vehicle for transportation autonomously moves along a driving path received from the server.

13. The method of claim 1, the method, further comprising;
recording an area including a vehicle coordinate received from the server using the camera; and
displaying an augmented image indicating a vehicle for transportation located in the recorded area.

14. The method of claim 13, wherein the step of displaying an augmented image indicating a vehicle for transportation located in the recorded area comprises converting the vehicle coordinate into a two-dimensional coordinate, and displaying the augmented image at a location corresponding to the two-dimensional coordinate in the recorded area.

15. The method of claim 1, the method, further comprising:
transmitting a destination to a server when the destination is input by the user; and
receiving a path and an expected driving fare from the terminal coordinate to the destination from the server.

16. The method of claim 15, wherein the server determines a suggested pickup location at which a distance between the suggested pickup location and the terminal coordinate is within a preset distance, and at which an expected driving fare from the suggested pickup location to the destination is lower than an expected driving fare from the terminal coordinate to the destination, and transmits the determined suggested pickup location to a user terminal.

17. The method of claim 16, wherein the method further comprises displaying the suggested pickup location on a map.

18. The method of claim 16, the method, further comprising;
recording an area including the suggested pickup location using the camera; and
displaying an augmented image indicating the suggested pickup location located in the recorded area.

19. The method of claim 18, the method, further comprising;
displaying a moving path to the suggested pickup location as an augmented image.

20. The method of claim 16, the method, further comprising;
outputting an interface as to whether a pickup location is changed to the suggested pickup location; and
receiving a pickup-location change signal from the user, and transmitting the received pickup-location change signal to the server,
wherein the sever transmits the suggested pickup location and a driving path to the suggested pickup location to the vehicle for transportation in response to the pickup-location change signal.
